(19) United States
(12) Patent Application Publication
(10) Pub. No.: US 2015/0153932 A1
(43) Pub. Date: Jun. 4, 2015

(54) MOBILE DEVICE AND METHOD OF DISPLAYING ICON THEREOF

(71) Applicant: SAMSUNG ELECTRONICS CO., LTD., Suwon-si (KR)

(72) Inventors: Zhicheng JIANG, Nanjing (CN); Lei GUO, Nanjing (CN); Xiaochun WANG, Nanjing (CN)

(73) Assignee: SAMSUNG ELECTRONICS CO., LTD., Suwon-si (KR)

(21) Appl. No.: 14/560,595

(22) Filed: Dec. 4, 2014

(30) Foreign Application Priority Data
Dec. 4, 2013 (CN) 201310648176.3
Nov. 25, 2014 (KR) 10-2014-0165499

(51) Int. Cl. G06F 3/0481; G06F 3/0484; G06F 3/0488; H04M 1/725

(52) U.S. Cl. CPC G06F 3/04817; H04M 1/72522; G06F 3/04842; G06F 3/0488

(57) ABSTRACT

Provided is a mobile device that includes icons of a plurality of applications. The mobile device includes a touch screen that receives a touch input from a user; and a controller that determines locations on the touch screen where recommended icons among the plurality of icons are displayed, on the basis of a location where the touch input is received, and controls the touch screen so that the recommended icons are displayed at the determined locations.

### RELATED APPLICATIONS

This application claims the benefit of State Intellectual Property Office (SIPO) of the People's Republic of China No. 201310648176.3, filed on Dec. 4, 2013, in State Intellectual Property Office (SIPO) of the People's Republic of China and Korean Patent Application No. 10-2014-0165499, filed on Nov. 25, 2014, in the Korean Intellectual Property Office, the disclosures of which are incorporated herein in their entirety by reference.

### BACKGROUND

1. Field

One or more exemplary embodiments relate to a mobile device and a method of displaying an icon of the mobile device, and more particularly, to a mobile device and method capable of displaying recommended icons among icons of a plurality of applications.

2. Description of the Related Art

Mobile devices mean portable computer devices. For example, the mobile device may include a smartphone, a tablet PC, an e-book reader, a camera, a camcorder, a game machine, a portable media player, a navigation device, a personal digital assistant (PDA), a notebook computer, and the like.

### SUMMARY

In general, a mobile device displays icons of applications according to the order of installing the applications or the order which is set by a user. When the mobile device displays a large number of icons according to the order of installing the applications or the order which is set by a user, it is a waste of time and inefficient for the user to directly search for an icon of an application to be executed among a plurality of icons.

Accordingly, a mobile device and method capable of efficiently displaying a plurality of icons are required.

Additional aspects will be set forth in part in the description which follows and, in part, will be apparent from the description, or may be learned by practice of the presented exemplary embodiments.

According to one or more exemplary embodiments, a mobile device that comprises icons of a plurality of applications includes a touch screen that receives a touch input from a user; and a controller that determines locations on the touch screen where recommended icons among the plurality of icons are displayed, on the basis of a location where the touch input is received, and controls the touch screen so that the recommended icons are displayed at the determined locations.

In the above-mentioned mobile device, the controller may determine a region where the recommended icons are displayed on the basis of the location where the touch input is received, and the locations where the recommended icons may be displayed are located within the region.

In the above-mentioned mobile device, the controller may determine locations where the recommended icons are displayed within a predetermined distance from the location where the touch input is received.

In the above-mentioned mobile device, the controller may determine the number of recommended icons to be displayed, on the basis of the location where the touch input is received.

In the above-mentioned mobile device, the region may include at least one of a circular shape, an elliptical shape, a semicircular shape, a fan shape, and a polygonal shape.

In the above-mentioned mobile device, the controller may terminate a display of the recommended icons when an input of touching the touch screen outside the region is received.

In the above-mentioned mobile device, the recommended icons may correspond to icons of most frequently used applications among the plurality of applications or may be set by the user.

In the above-mentioned mobile device, the touch input may be an input of touching the touch screen for a predetermined duration or more.

According to one or more exemplary embodiments, a method of displaying an icon of a mobile device includes receiving a touch input from a user through a touch screen of the mobile device; determining locations on the touch screen on which recommended icons among icons of a plurality of applications are displayed, on the basis of a location where the touch input is received; and displaying the recommended icons at the determined locations.

The method may further include determining a region where the recommended icons are displayed, on the basis of the location where the touch input is received. In addition, the locations where the recommended icons may be displayed are located within the region.

In the above-mentioned method, the locations where the recommended icons may be displayed are located within a predetermined distance from the location where the touch input is received.

The method may further include determining the number of recommended icons to be displayed, on the basis of the location where the touch input is received.

In the above-mentioned method, the region may include at least one of a circular shape, an elliptical shape, a semicircular shape, a fan shape, and a polygonal shape.

The method may further include terminating a display of the recommended icons when an input of touching the touch screen outside the region is received.

In the above-mentioned method, the recommended icons may correspond to icons of most frequently used applications among the plurality of applications or may be set by the user.

In the above-mentioned method, the touch input may be an input of touching the touch screen for a predetermined duration or more.

According to one or more exemplary embodiments, provided is a computer readable recording medium having embodied thereon a computer program for executing the method of any one of the above-mentioned methods.

### BRIEF DESCRIPTION OF THE DRAWINGS

These and/or other aspects will become apparent and more readily appreciated from the following description of the exemplary embodiments, taken in conjunction with the accompanying drawings in which:

FIGS. 1A and 1B are conceptual diagrams illustrating an operation of causing a mobile device to display recommended icons;

FIG. 2 is a flowchart illustrating an operation of causing a mobile device according to an exemplary embodiment to display recommended icons;

FIG. 3 is a diagram illustrating an operation of causing a mobile device according to an exemplary embodiments to receive a touch input;

FIGS. 4A and 4B are diagrams illustrating an operation of causing a mobile device according to an exemplary embodiment to display recommended icons on the basis of inputs described in FIG. 3;

FIG. 5 is a diagram illustrating another operation of receiving a touch input by a mobile device according to an exemplary embodiment;

FIGS. 6A to 6C are diagrams illustrating an operation of causing a mobile device according to an exemplary embodiment to display recommended icons on the basis of inputs described in FIG. 5;

FIGS. 7A to 7C are diagrams illustrating an operation of causing a mobile device according to another exemplary embodiment to display recommended icons on the basis of the inputs described in FIG. 5;

FIGS. 8A and 8B are diagrams illustrating an operation of causing a mobile device according to an exemplary embodiment to display subordinated recommended icons;

FIGS. 9A and 9B are diagrams illustrating an operation of causing a mobile device according to an exemplary embodiment to terminate a display of recommended icons; and

FIG. 10 is a block diagram illustrating the structure of a mobile device according to an exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements, not excluding the other elements. Expressions such as “at least one of,” when preceding a list of elements, modify the entire list of elements and do not modify the individual elements of the list.

In addition, throughout the specification, when it is referred to as being “displayed on a screen of a device”, it can be understood that a specific image is output to the screen of the device. Accordingly, being “displayed on a screen of a device” includes “outputting to the screen of the device”.

Hereinafter, an exemplary embodiment of the present disclosure will be described in detail with reference to the accompanying drawings.

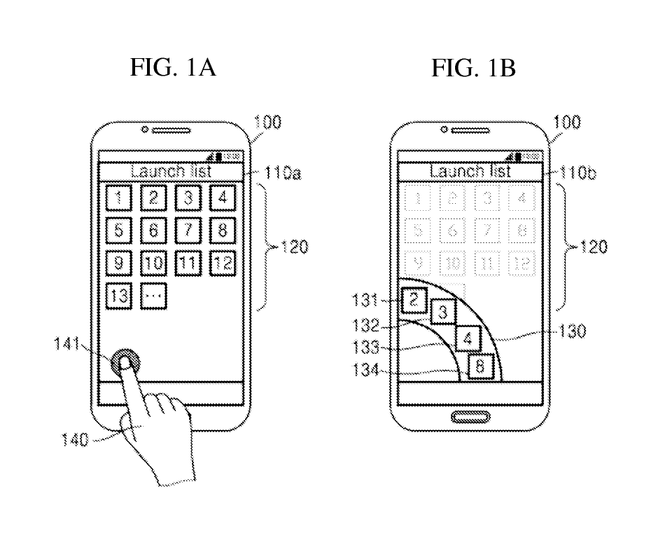

FIG. 1 is a conceptual diagram illustrating an operation of causing a mobile device 100 to display recommended icons 131, 132, 133, and 134 according to an exemplary embodiment. FIG. 1A shows a user interface screen 110a when the mobile device 100 receives a touch input. FIG. 1B shows a user interface screen 110b of the mobile device 100 on which the recommended icons 131, 132, 133, and 134 are displayed.

As described above, the “mobile device 100” means a portable computer device. For example, the mobile device 100 may include a smartphone, a tablet PC, an e-book reader, a camera, a camcorder, a game machine, a portable media player, a navigation device, a personal digital assistant (PDA), a notebook computer, and the like.

The “recommended icons 131, 132, 133, and 134” may mean icons that are priorly displayed on a screen by the mobile device 100 among icons 120a of a plurality of applications included in the mobile device 100. In detail, the mobile device 100 may display the recommended icons 131, 132, 133, and 134 at the head of the present screen. In other words, when other icons and widgets are displayed in advance at locations where the recommended icons 131, 132, 133, and 134 are to be displayed, the mobile device 100 may display the recommended icons 131, 132, 133, and 134 so as to overlap icons and widgets.

For example, the recommended icons 131, 132, 133, and 134 may be icons corresponding to applications which are used most frequently. In detail, when a user executes a messenger application most frequently for a month, the recommended icons 131, 132, 133, and 134 may include a messenger application.

Alternatively, the recommended icons 131, 132, 133, and 134 may set by a user. In detail, the user may set a social network service (SNS) application, a schedule management application, and the like as recommended icons.

The mobile device 100 includes icons 120 of a plurality of applications.

For example, the mobile device 100 may dispose the icons 120 of the plurality of applications according to the order of installing applications and may display the icons on the screen. For convenience of description, FIG. 1A shows the plurality of icons 120 by Arabic numerals according to the arrangement order. However, the plurality of icons 120 may include various forms such as characters, numerals, figures, signs, and images.

The mobile device 100 receives a touch input 140 from a user.

Here, the touch input 140 means a user input for calling the recommended icons 131, 132, 133, and 134. For example, the touch input 140 may be an input of touching a touch screen for a predetermined duration or more. Alternatively, the touch input 140 may be an input of touching the touch screen twice for a predetermined duration or more. However, an input for displaying the recommended icons 131, 132, 133, and 134 is not limited thereto and may be set in various manners by a user.

In addition, the touch input 140 may be received on a menu screen of the mobile device 100. In detail, the touch input 140 may be received on a menu screen 110a on which widget or icons of applications are displayed.

The mobile device 100 determines locations on the touch screen on which the recommended icons 131, 132, 133, and 134 among the plurality of icons 120 are displayed, on the basis of a location 141 where the touch input 140 is received. In other words, the locations where the recommended icons 131, 132, 133, and 134 are received are determined by the location 141 where a touch input is received.

For example, the mobile device 100 may determine locations at which the recommended icons 131, 132, 133, and 134 are displayed within a predetermined distance from the location 141 where the touch input 140 is received. When the recommended icons 131, 132, 133, and 134 are displayed within a predetermined distance from the location 141 where the touch input 140 is received, a user may easily control the mobile device 100 using one finger even on a large touch screen of the mobile device 100 such as a tablet PC.

In addition, the mobile device 100 may determine a region 130 where recommended icons are displayed (hereinafter, referred to as a “recommended icon display region”) on the basis of the location 141 where the touch input 140 is received. In addition, locations where the recommended icons 131, 132, 133, and 134 are displayed may be located within the recommended icon display region 130.

According to the current exemplary embodiment, the recommended icon display region 130 may be located within a predetermined distance from the location where the touch input 140 is received. In addition, the recommended icon display region 130 may include an edge of the touch screen which is closest to the location 141 where the touch input 140 is received. For example, referring to FIG. 1B, the location 141 having the touch input 140 received therein is located at a left lower end of the touch screen, and thus the recommended icon display region 130 may include an edge of the left lower end of the touch screen.

According to the current exemplary embodiment, the recommended icons 131, 132, 133, and 134 may be displayed on the touch screen without the recommended icon display region 130. In detail, the mobile device 100 may determine coordinates on the touch screen with respect to each of the recommended icons 131, 132, 133, and 134. In addition, the mobile device 100 may display the recommended icons 131, 132, 133, and 134 on the determined coordinates. The recommended icon display region 130 may have at least one of a circular shape, an elliptical shape, a semicircular shape, a fan shape, and a polygonal shape. For example, referring to FIG. 1B, the recommended icon display region 130 having a fan shape is shown. The shape of the recommended icon display region 130 may vary depending on the location 141 where the touch input 140 is received. In addition, the shape of the recommended icon display region 130 may vary by a user.

In addition, the mobile device 100 may dispose the recommended icons 131, 132, 133, and 134 in order according to recommendation rankings. For example, it is assumed that the mobile device 100 determines the recommendation ranking according to the frequency of use. Referring to FIG. 1B, an application corresponding to an icon 2 131 may be most frequently used and may have the highest recommendation ranking. In addition, an application corresponding to an icon 3 132 may be second most frequently used, an application corresponding to an icon 4 133 may be third most frequently used, and an application corresponding to an icon 8 134 may be fourth most frequently used.

The mobile device 100 displays the recommended icons 131, 132, 133, and 134 on the determined locations.

In detail, the mobile device 100 may determine the number of recommended icons 131, 132, 133, and 134 to be displayed on the touch screen, on the basis of the location where the touch input 140 is received. For example, as the touch input 140 is close to the center of the touch screen, a larger number of recommended icons may be displayed.

In addition, when the recommended icons 131, 132, 133, and 134 are displayed, the mobile device 100 may translucently display elements other than the recommended icons 131, 132, 133, and 134 displayed on the touch screen. For example, the mobile device 100 may translucently display the icons 120 other than the recommended icons 131, 132, 133, and 134 while displaying the recommended icons 131, 132, 133, and 134.

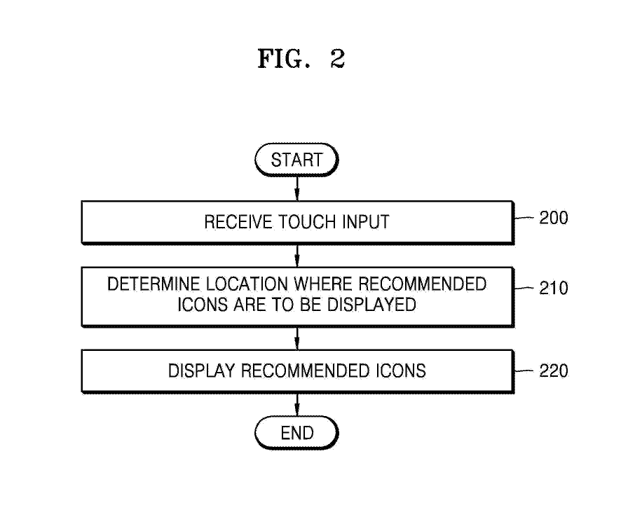

FIG. 2 is a flowchart illustrating an operation of causing a mobile device according to an exemplary embodiment to display recommended icons.

An example shown in FIG. 2 is constituted by processes that are processed in time series by the mobile device 100 shown in FIG. 1. Accordingly, even when a description is omitted below, the above description regarding the operation of the mobile device 100 shown in FIG. 1 may be applied to the example shown in FIG. 2.

In operation 200, the mobile device 100 receives a touch input from a user. In detail, the touch input means a user input for calling recommended icons.

In operation 210, the mobile device 100 determines a location on the touch screen on which the recommended icons are to be displayed, on the basis of the location of the touch input received in operation 200.

In operation 220, the mobile device 100 displays the recommended icons at the location determined in operation 210.

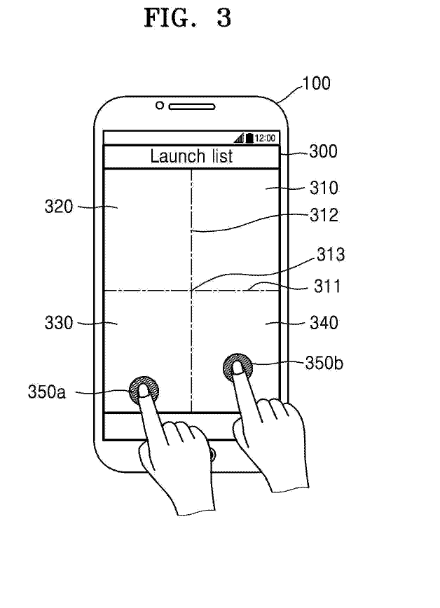

FIG. 3 is a diagram illustrating an operation of causing the mobile device 100 according to an exemplary embodiment to receive touch inputs 350a and 350b.

As described above, the mobile device 100 displays the recommended icons on the basis of the location where the touch input is received.

For example, the mobile device 100 may display the recommended icons on a quadrant where the touch input is received. In detail, a touch screen 300 of the mobile device 100 may be divided into a first quadrant 310, a second quadrant 320, a third quadrant 330, and a fourth quadrant 340 on the basis of a horizontal axis 311 and a vertical axis 312 which pass through a central point 313. In addition, when the third quadrant 330 receives a touch input such as a touch input 350a, the mobile device 100 may display recommended icons in the third quadrant 330 or may display the recommended icons at locations that are relatively close to the third quadrant 330. In addition, when the fourth quadrant 340 receives a touch input such as a touch input 350b, the mobile device 100 may display the recommended icons in the fourth quadrant 340 or may display the recommended icons at locations that are relatively close to the fourth quadrant 340.

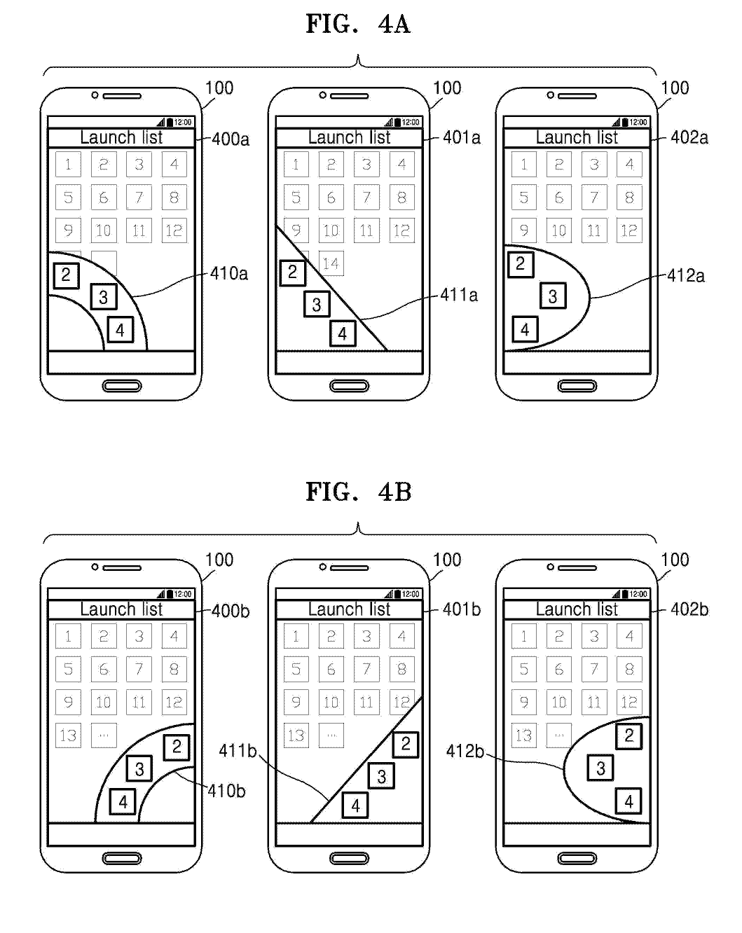

FIG. 4 is a diagram illustrating an operation of causing a mobile device according to an exemplary embodiment to display recommended icons on the basis of the inputs 350a and 350b described in FIG. 3.

In detail, FIG. 4A is a diagram illustrating an operation of causing the mobile device 100 to display recommended icons in the third quadrant 330 on the basis of the location of the touch input received in the third quadrant 330. On the other hand, FIG. 4B is a diagram illustrating an operation of causing the mobile device 100 to display recommended icons in the fourth quadrant 340 on the basis of the location of the touch input 350b received in the fourth quadrant 340.

As described above, the shape of the recommended icon display region may be set by a user. For example, the shape of the recommended icon display region may include at least one of a circular shape, an elliptical shape, a semicircular shape, a fan shape, and a polygonal shape.

For example, referring to 400a, it is assumed that a display region 410a of recommended icons has a fan shape. Then, the mobile device 100 may determine the fan-shaped recommended icon display region 410a in a third quadrant on the basis of the touch input 350a and may display the recommended icons on a screen.

In addition, referring to 400b, the mobile device 100 may determine a fan-shaped recommended icon display region 410b in a fourth quadrant on the basis of the touch input 350b and may display recommended icons on the screen.

Alternatively, referring to 401a, it is assumed that a display region 411a of recommended icons has a triangular shape. The mobile device 100 may determine the recommended icon display region 411a having a triangular shape in a third quadrant on the basis of the touch input 350a and may display the recommended icons on the screen.

In addition, referring to 401b, the mobile device 100 may determine a recommended icon display region 411b having a triangular shape in a fourth quadrant on the basis of the touch input 350b and may display the recommended icons on the screen.

Alternatively, referring to 402a, it is assumed that a display region 412a of recommended icons has an elliptical shape. The mobile device 100 may determine a recommended icon display region 412a having an elliptical shape in a third quadrant on the basis of the touch input 350a and may display the recommended icons on the screen.

In addition, referring to 402b, the mobile device 100 may determine a recommended icon display region 412b having an elliptical shape in a fourth quadrant on the basis of the touch input 350b and may display the recommended icons on the screen.

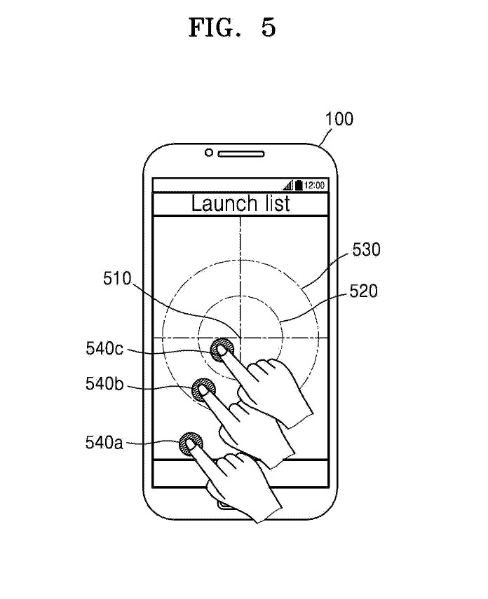

FIG. 5 is a diagram illustrating another operation of causing the mobile device 100 according to an exemplary embodiment to receive touch inputs 540a, 540b, and 540c.

As described above, the mobile device 100 may determine the number of recommended icons to be displayed on a touch screen, on the basis of locations where the touch inputs 540a, 540b, and 540c are received. For example, as a distance between a center 510 of the touch screen 500 and the touch inputs 540a, 540b, and 540c decreases, a larger number of recommended icons may be displayed. In detail, the number of recommended icons to be displayed on a touch screen 500 may be determined according to a distance between a location where a touch input is received and the center 510 of the touch screen.

Referring to FIG. 5, the touch input 540a, the touch input 540b, and the touch input 540c are shown in a descending order of distances from the center 510 of the touch screen 500. In detail, the mobile device 100 sets a small circle 520 and a large circle 530 on the basis of the center 510. The touch input 540a is located outside the large circle 530, the touch input 540b is located between the large circle 530 and the small circle 520, and the touch input 540c is located within the small circle 520.

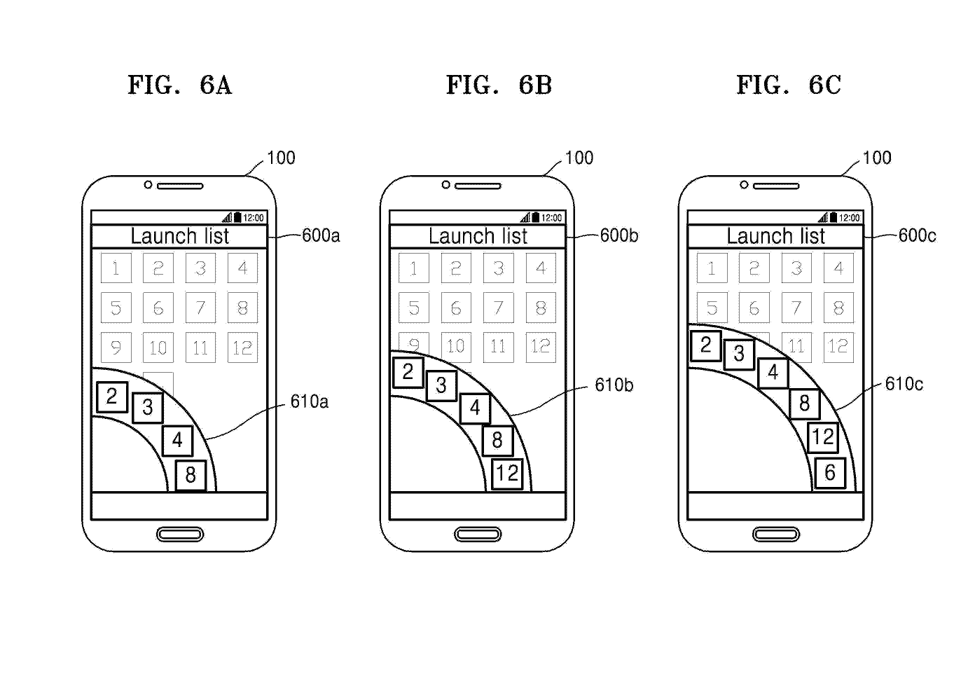

FIG. 6 is a diagram illustrating an operation of causing a mobile device according to an exemplary embodiment to display recommended icons on the basis of the touch inputs 540a, 540b, and 540c described in FIG. 5.

For example, FIG. 6A shows the mobile device 100 that displays four recommended icons on the basis of a location where the touch input 540a is received. In detail, since the touch input 540a is received in a third quadrant of a touch screen 600a, the mobile device 100 may determine a recommended icon display region 610a in the third quadrant. In addition, when a touch input such as the touch input 540a is received from the outside of the large circle 530, the mobile device 100 displays four recommended icons within the recommended icon display region 610a.

Alternatively, FIG. 6B shows the mobile device 100 that displays five recommended icons on the basis of a location where the touch input 540b is received. In detail, since the touch input 540b is received in a third quadrant of a touch screen 600b, the mobile device 100 may determine a recommended icon display region 610b in the third quadrant of the touch screen 600b. In addition, when a touch input such as the touch input 540b is received at a location between the large circle 530 and the small circle 520, the mobile device 100 displays five recommended icons within the recommended icon display region 610b.

Alternatively, FIG. 6C shows the mobile device 100 that displays six recommended icons on the basis of a location where the touch input 540c is received. In detail, since a touch input 540c of a touch screen 600c is received in a third quadrant, the mobile device 100 may determine a recommended icon display region 610c in the third quadrant of the touch screen 600c. In addition, when a touch input such as the touch input 540c is received within the small circle 520, the mobile device 100 displays six recommended icons within a recommended icon display region 610c.

In addition, the mobile device 100 may dispose the recommended icons 131, 132, 133, and 134 in order according to a recommendation ranking. For example, it is assumed that the mobile device 100 determines the recommendation ranking according to the frequency of use. Referring to FIGS. 6A to 6C, the frequency of use may be highest in the order of applications corresponding to icons 2, 3, 4, 8, 12, and 16.

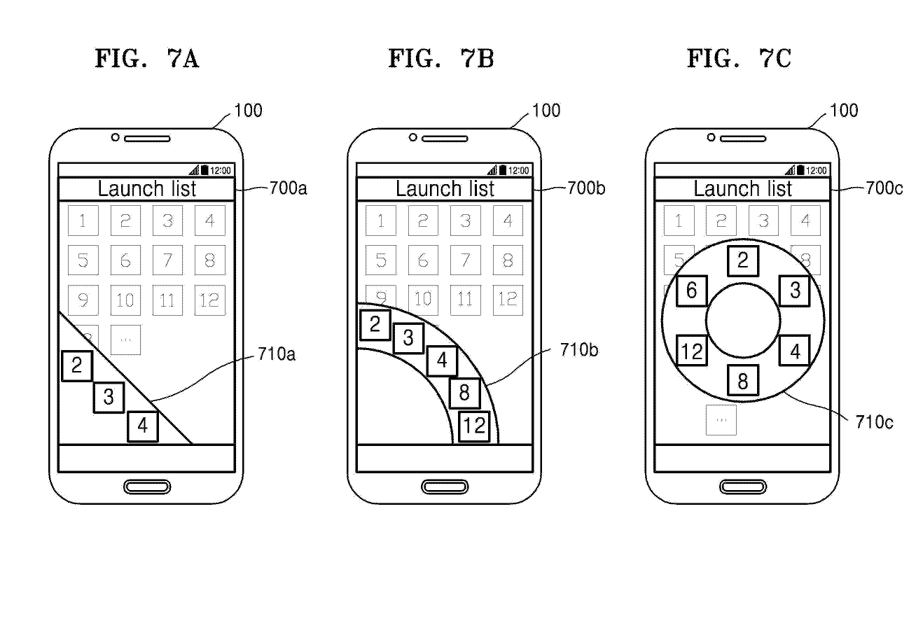

FIG. 7 is a diagram illustrating an operation of causing a mobile device 100 according to another embodiment to display recommended icons on the basis of the inputs described in FIG. 5.

As described above, the shapes of recommended icon display regions 710a, 710b, and 710c may vary according to locations where touch inputs 540a, 540b, and 540c are received.

For example, referring to FIG. 7A, when a touch input such as the touch input 540a is received from the outside of a large circle 530, the mobile device 100 may determine a recommended icon display region 610a having a triangular shape and may display three recommended icons on a touch screen 700a.

Alternatively, referring to FIG. 7B, when a touch input such as the touch input 540b is received between a large circle 530 and a small circle 520, the mobile device 100 may determine a recommended icon display region 710b having a fan shape and may display five recommended icons on a touch screen 700b.

Alternatively, referring to FIG. 7C, when a touch input such as the touch input 540c is received within a small circle 520, the mobile device 100 may determine a recommended icon display region 710c having a circular shape and may display six recommended icons on a touch screen 700c.

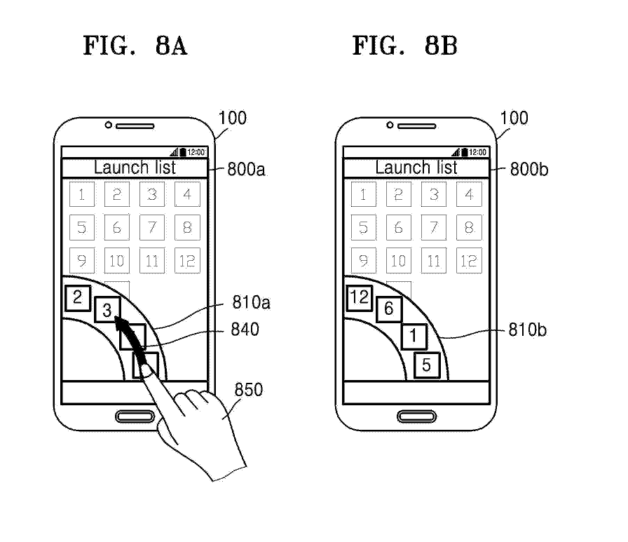

FIG. 8 is a diagram illustrating an operation of causing a mobile device according to an exemplary embodiment to display subordinated recommended icons. Here, the subordinated recommended icons mean recommended icons having a recommendation ranking lower than those of unsubordinated recommended icons.

For example, referring to FIG. 8A, the mobile device 100 may receive a sliding input 850 counterclockwise 840 within a recommended icon display region 810a through a touch screen 800a. Here, a sliding input 920 may be an input for calling subordinated recommended icons.

The input for calling subordinated recommended icons is not limited to the sliding input 850 and may be set in various manners by a user.

Referring to FIG. 8B, the mobile device 100 displaying subordinated recommended icons is shown.

When the sliding input 850 for calling subordinated recommended icons is received, the mobile device 100 may display the subordinated recommended icons within a recommended icon display region 810b.

For example, the mobile device 100 may change icons 2, 3, 4, and 8 which are unsubordinated recommended icons to icons 12, 6, 1, and 5 which are subordinated recommended icons and display the changed icons within the recommended icon display region 810b.

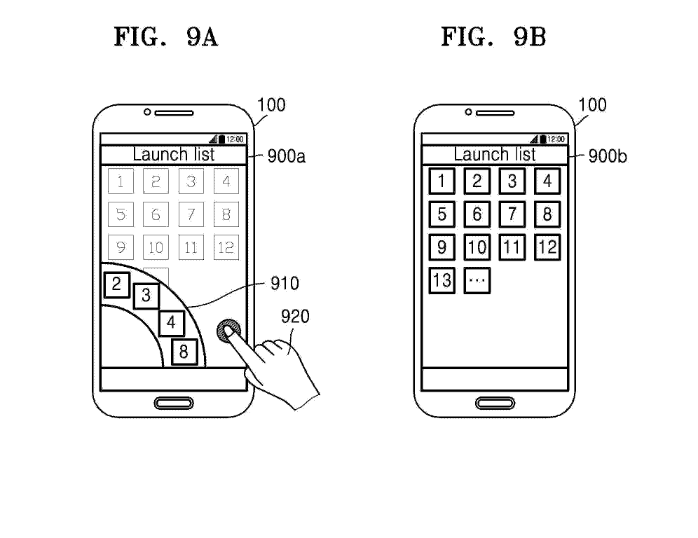

FIG. 9 is a diagram illustrating an operation of causing the mobile device 100 according to an exemplary embodiment to terminate a display of recommended icons.

FIG. 9A shows an operation of receiving a touch input 920 for causing the mobile device 100 to terminate a display of recommended icons through a touch screen 900a.

For example, when the touch input 920 is received from the outside of a recommended icon display region 910, the mobile device 100 may terminate a display of recommended icons.

In addition, when any one of the recommended icons is selected and an application is executed, the mobile device 100 may terminate a display of recommended icons.

FIG. 9B shows a touch screen 900b after the mobile device 100 terminates a display of recommended icons.

For example, when a touch input 920 for terminating a display of recommended icons is received, the mobile device 100 may display a user interface screen before displaying the recommended icons on the touch screen 900b. In detail, icons of a plurality of applications which have been translucently displayed may be displayed as the original opaque icons.

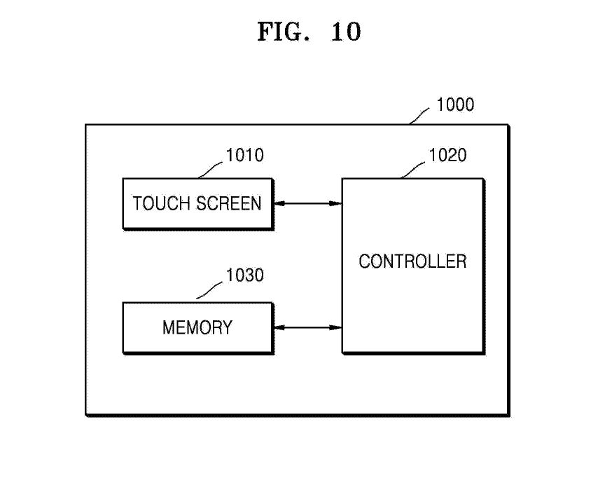

FIG. 10 is a block diagram showing the structure of a mobile device 1000 according to an exemplary embodiment.

The mobile device 1000 shown in FIG. 10 may correspond to the mobile device 100 described above with reference to FIGS. 1 to 9.

The mobile device 1000 according to the current exemplary embodiment includes a touch screen 1010 and a controller 1020.

In addition, all of components shown in FIG. 10 are not the essential components of the mobile device 100. The mobile device 100 may be configured by a larger number of components than those shown in FIG. 10. For example, the mobile device 1000 may further include a memory 1030.

A touch screen 1010 may include a touch pad (not shown) coupled to a display panel (not shown). In the touch screen 1010, a user interface screen is displayed on the display panel. When a user touches a predetermined point of the user interface screen to input a predetermined command, the touch pad senses the user's touch and may recognize the predetermined command input by the user.

In detail, when the touch screen 1010 is formed as a touch pad and a user touches a predetermined point of the user interface screen, the touch screen 1010 senses the touched point and then may transfer the sensed information to the controller 1020. Then, the controller 1020 may recognize a user's request or command corresponding to the sensed information and may perform the recognized request or command.

For example, the touch screen 1010 may receive a touch input for calling recommended icons from a user. The touch input for calling recommended icons may be an input of touching the touch screen 1010 for a predetermined duration or more.

In addition, the touch screen 1010 may display the recommended icons under the control of the controller 1020.

In general, the controller 1020 controls the overall operation of the mobile device 1000. For example, the controller 1020 may generally control the touch screen 1010 and the like by executing programs stored in a memory 1030.

For example, the controller 1020 may determine locations on a touch screen on which recommended icons among a plurality of icons are displayed, on the basis of a location where a touch input for calling the recommended icons is received. In addition, the controller 1020 may control the touch screen 1010 so that the recommended icons are displayed at the determined locations.

In detail, the controller 1020 may determine a region where the recommended icons are displayed, on the basis of the location where the touch input for calling the recommended icons is received. In addition, the recommended icons may be located within a recommended icon display region.

In addition, the controller 1020 may determine locations where the recommended icons are displayed within a predetermined distance from the location where the touch input for calling the recommended icons is received.

In addition, the controller 1020 may determine the number of recommended icons to be displayed on the touch screen, on the basis of the location where the touch input for calling the recommended icons is received.

The memory 1030 may store a program for processing and controlling the controller 1020 and may store data which is input to and output from the mobile device 1000.

The memory 1030 may include at least one of storage media such as flash memory type, hard disk type, and multimedia card micro type memories (for example, an SD or XD memory), a random access memory (RAM) a static random access memory (SRAM), a read-only memory (ROM), an electrically erasable programmable read-only memory (EEPROM), a programmable read-only memory (PROM), a magnetic memory, a magnetic disc, and an optical disc.

For example, the memory 1030 may store the frequency of use of applications, information on recommended icons that are set by a user, the shape of a recommended icon display region, and the like.

According to the above-mentioned mobile device and method of displaying an icon of the mobile device, a user may efficiently execute an application corresponding to a recommended icon. In detail, even when the mobile device includes a large number of icons, the user may easily select an icon to be executed from recommended icons.

In addition, even when a mobile device has a large screen such as a tablet PC, a user may easily control the mobile device using one finger as in a case where a recommended icon is called to execute a predetermined application.

Meanwhile, the above-described exemplary embodiments may be written by a computer-executable program and may be embodied in a general-purpose digital computer that operates the program by using a computer-readable recording medium.

A computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and carrier waves (for example, transmission through the Internet).

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A mobile device that comprises icons of a plurality of applications, the mobile device comprising:
a touch screen that receives a touch input from a user; and
a controller that determines locations on the touch screen where recommended icons among the plurality of icons are displayed, on the basis of a location where the touch input is received, and controls the touch screen so that the recommended icons are displayed at the determined locations.

2. The mobile device of claim 1, wherein the controller determines a region where the recommended icons are displayed on the basis of the location where the touch input is received, and the locations where the recommended icons are displayed are located within the region.

3. The mobile device of claim 1, wherein the controller determines locations where the recommended icons are displayed within a predetermined distance from the location where the touch input is received.

4. The mobile device of claim 1, wherein the controller determines the number of recommended icons to be displayed, on the basis of the location where the touch input is received.

5. The mobile device of claim 2, wherein the region comprises at least one of a circular shape, an elliptical shape, a semicircular shape, a fan shape, and a polygonal shape.

6. The mobile device of claim 2, wherein the controller terminates a display of the recommended icons when an input of touching the touch screen outside the region is received.

7. The mobile device of claim 1, wherein the recommended icons correspond to icons of most frequently used applications among the plurality of applications or are set by the user.

8. The mobile device of claim 1, wherein the touch input is an input of touching the touch screen for a predetermined duration or more.

9. A method of displaying an icon of a mobile device, the method comprising:
receiving a touch input from a user through a touch screen of the mobile device;
determining locations on the touch screen on which recommended icons among icons of a plurality of applications are displayed, on the basis of a location where the touch input is received; and
displaying the recommended icons at the determined locations.

10. The method of claim 9, further comprising determining a region where the recommended icons are displayed, on the basis of the location where the touch input is received,
wherein the locations where the recommended icons are displayed are located within the region.

11. The method of claim 9, wherein the locations where the recommended icons are displayed are located within a predetermined distance from the location where the touch input is received.

12. The method of claim 9, further comprising determining the number of recommended icons to be displayed, on the basis of the location where the touch input is received.

13. The method of claim 10, wherein the region comprises at least one of a circular shape, an elliptical shape, a semicircular shape, a fan shape, and a polygonal shape.

14. The method of claim 10, further comprising terminating a display of the recommended icons when an input of touching the touch screen outside the region is received.

15. The method of claim 9, wherein the recommended icons correspond to icons of most frequently used applications among the plurality of applications or are set by the user.

16. The method of claim 9, wherein the touch input is an input of touching the touch screen for a predetermined duration or more.

17. A computer readable recording medium having embodied thereon a computer program for executing the method of claim 9.
